(19) United States
(12) Patent Application Publication
(10) Pub. No.: US 2010/0253107 A1
(43) Pub. Date: Oct. 7, 2010

(54) WORKPIECE TRANSPORT DEVICE

(75) Inventor: Daniel Ruchti, Singapore (SG)

Correspondence Address: BRINKS HOFER GILSON & LIONE, P.O. BOX 10395, CHICAGO, IL, 60610, US

(73) Assignee: Hatebur Umformmaschinen AG, Reinach (CH)

(21) Appl. No.: 12/161,437

(22) PCT Filed: Jan. 19, 2007
(86) PCT No.: PCT/CH2007/000027

§ 371 Date: Jul. 18, 2008

(30) Foreign Application Priority Data
Jan. 24, 2006 (CH) 112/06

(51) Int. Cl. B25J 15/00

(52) U.S. Cl. 294/106

(57) ABSTRACT

A workpiece transport device for a forming machine includes at least one gripping tongs, which has two non-crossing gripper arms that are pivotable with respect to one another, where the arms each have a gripping end for gripping a workpiece. Each of the two gripper arms are articulated at ends opposite from the gripping end on a common guide head and, in a middle region between the two ends, and on its own link bar. The two link bars are each rotatable about a fixed pivot, wherein the fixed pivot of the link bar of one gripper arm is arranged closer to the other gripper arm than is the fixed pivot of the link bar of the other gripper arm.

### BACKGROUND OF THE INVENTION

The present invention relates to a workpiece transport device for a forming machine.

In forming machines customary today, workpieces are normally placed in forming stations and/or removed therefrom again after the forming by means of workpiece transport devices. Multi-stage forming machines have a plurality of forming stations arranged one after the other in which one workpiece after another is processed. The transport of the workpiece between the individual forming stations being effected by means of a workpiece transport device.

Known workpiece transport devices comprise a plurality of gripping tongs with which the workpieces in the individual forming stations can be simultaneously gripped, transported and then released again. For that purpose, the gripping tongs are driven by means of a drive mechanism together in the rhythm of the machine.

Gripping tongs of a wide variety of kinds are part of the prior art. For example, DE 35 23 323 A1 discloses gripping tongs having two non-crossing gripper arms which are pivotable with respect to one another, the arms each having a gripping end for gripping a workpiece. In the case of those gripping tongs, each of the two gripper arms is articulated at its end opposite from the gripping end on a common guide head and, in a middle region between the two ends, on its own link bar. The two link bars are rotatable about a common, fixed pivot. By upward displacement of the guide head, starting from a lower end position, the gripping ends of the two gripper arms are pivoted first away from one another and then towards one another again, while simultaneously being raised. On downward displacement of the guide head, starting from an upper end position, the gripping ends of the two gripper arms are pivoted first away from one another and then towards one another again, while simultaneously being lowered. A disadvantage of such gripping tongs is that the two gripper arms are pivoted a relatively large distance outwards, so that a relatively large amount of space is required at the sides.

In view of the disadvantages of the previously known workpiece transport devices, the problem underlying the invention is to provide a workpiece transport device of the kind mentioned at the beginning in which the gripper arms of the at least one gripping tongs require less space at the sides.

### SUMMARY

The core of the invention lies in the following: a workpiece transport device for a forming machine comprises at least one gripping tongs which has two non-crossing gripper arms which are pivotable with respect to one another, the arms each having a gripping end for gripping a workpiece. Each of the two gripper arms is articulated at its end opposite from the gripping end on a common guide head and, in a middle region between the two ends, on its own link bar. The two link bars are each rotatable about a fixed pivot. According to the invention, the fixed pivot of the link bar of one gripper arm is arranged closer to the other gripper arm than is the fixed pivot of the link bar of that other gripper arm.

Because the link bars of the two gripper arms are arranged in such a way that they are rotatable about different fixed pivots, and in addition the fixed pivots of the link bars are in each case shifted towards the gripper arm not articulated on the respective link bar, the two gripper arms, on being pivoted apart from one another, are pivoted outwards to a lesser extent. The at least one gripping tongs accordingly requires less space at the sides than in the case of comparable workpiece transport devices of the prior art.

The guide head is advantageously linearly displaceable along a fixed guide means so that, on rotation of a link bar, the guide head is displaced linearly by the one gripper arm on which that link bar is articulated, with the result that the other gripper arm is displaced too and, as a result of its being articulated on the other link bar, is rotated in the opposite direction to the first gripper arm. That enables the gripping tongs to be opened and closed by rotation of a link bar, that is to say there can be used as drive means a rotary drive means which acts on one of the link bars. An advantage of such a rotary drive means is that it can be sealed more easily than a linear drive means that makes contact with, for example, the guide head. In addition, it is simpler to implement and requires less space than a linear drive means.

Preferably, the workpiece transport device has a biasing device which exerts on the guide head a force in the direction towards the gripping ends of the gripper arms. As a result of that biasing device, the gripping tongs is held in the gripping position or is pressed into the gripping position when there is no active drive to open the gripping tongs. The biasing also prevents any undefined wobbling of the gripper arms.

Advantageously, the two gripper arms are articulated on a common pivot shaft in the guide head. The guide head can thus be of relatively compact construction.

Preferably, one end of each of the two link bars is mounted in a fixed housing part of the gripping tongs so as to be rotatable about the fixed pivot belonging to the respective link bar. That means that the respective pivot of the link bars is located at one end of the link bar in question and the whole length of the link bars can be utilised because the other end of each link bar is articulated on the associated gripper arm.

Preferably, the workpiece transport device has a rotary drive means with which one of the link bars is rotatable. As already mentioned, a rotary drive means has the advantage that it is easier to seal than a linear drive means. In addition, it is simpler to implement and requires less space than a linear drive means.

The rotary drive means advantageously has a drive rod which is displaceable in the longitudinal direction and is connected to one of the link bars by means of intermediate members, so that the link bar in question is rotatable by longitudinal displacement of the drive rod. Such a drive rod can in principle be used for simultaneously driving a plurality of gripping tongs arranged one next to the other, by connecting the rod by means of intermediate members to one of the link bars of each gripping tongs.

Preferably, the workpiece transport device has a plurality of gripping tongs arranged one next to the other which are operable in parallel by means of a drive means. The workpieces in the individual forming stations can thus be simultaneously gripped, transported and then released again.

Advantageously, the gripper arms and the link bars are constructed and arranged in such a way that, on rotation of the link bars from one end position to the other, the gripping ends of the two gripper arms are pivoted first away from one another and then towards one another again. In the two end positions, the at least one gripping tongs then requires relatively little space at the sides. Transverse displacement of the at least one gripping tongs with or without a workpiece takes place timewise in such a way that the opening sequence of the gripping tongs allows collision-free movement. For time-related reasons, the transverse movement has usually already begun before the gripping tongs has reached one of the end positions.

The workpiece transport device according to the invention is described in greater detail below on the basis of an exemplary embodiment with reference to the accompanying drawings.

### BRIEF DESCRIPTION OF THE DRAWINGS

FIG. 1 shows a die-side portion of a multi-stage forming machine with an exemplary embodiment of a workpiece transport device according to a specific embodiment of the invention having four gripping tongs;

FIG. 2A to 2C show from the front important elements of one of the four gripping tongs of the workpiece transport device of FIG. 1 with a workpiece in a lower end position, a middle position and an upper end position;

FIG. 3A to 3C show from behind the gripping tongs elements of FIG. 2A with a workpiece in a lower end position, a middle position and an upper end position;

FIG. 4A to 4C show the gripping tongs elements of FIG. 2A with a workpiece in a perspective view obliquely from behind in a lower end position, a middle position and an upper end position;

FIG. 5 shows the gripping tongs elements of FIG. 2A with further elements of the gripping tongs and a rotary drive means in a perspective view obliquely from the front;

FIG. 6 shows the gripping tongs elements and rotary drive means elements of FIG. 5 in a perspective view obliquely from behind, part of the housing having been omitted for ease of viewing;

FIG. 7 shows the gripping tongs elements and rotary drive means elements of FIG. 5 from behind, part of the housing having been omitted for ease of viewing;

FIG. 8 shows a sectional view corresponding to line A-A in FIG. 7, with additional housing parts being shown;

FIG. 9A to 9C show the gripping tongs elements and rotary drive means elements of FIG. 5 from the front in a lower end position, a middle position and an upper end position;

FIG. 10A to 10C show from behind the gripping tongs elements and rotary drive means elements of FIG. 5 without housing parts and biasing spring in a lower end position, a middle position and an upper end position;

FIG. 11 shows an important part of the rotary drive means of the workpiece transport device of FIG. 1; and

FIG. 12 shows a partly sectional view of the forming machine with the workpiece transport device of FIG. 1.

### DETAILED DESCRIPTION OF THE PREFERRED EMBODIMENTS

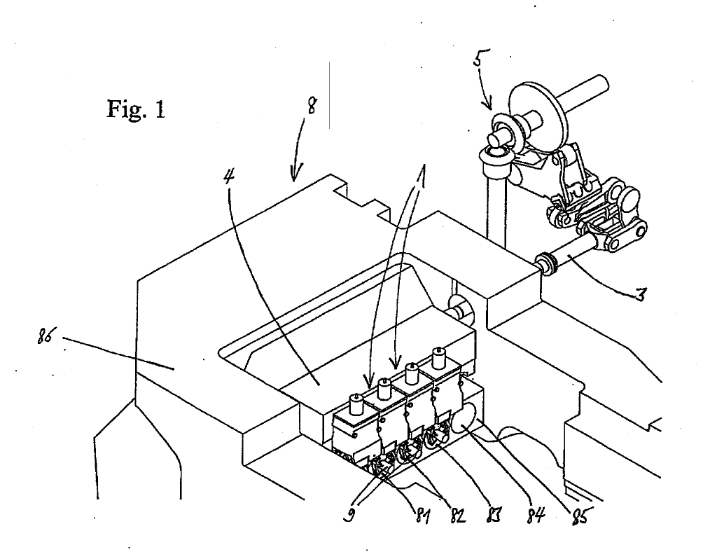

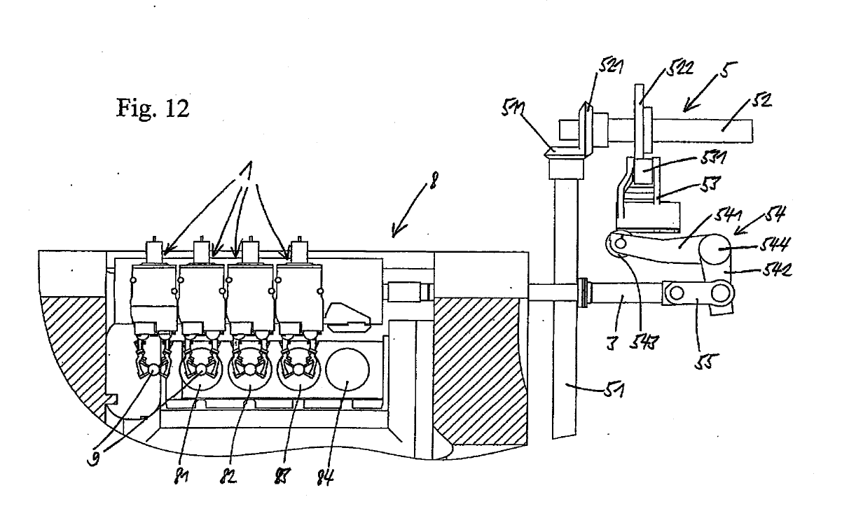

The exemplary embodiment of a multi-stage forming machine 8 shown in FIG. 1 comprises four forming stations, of which in each case a die 81, 82, 83, 84 is visible. The dies 81, 82, 83, 84 are mounted in a fixed die holding means 85 which is joined indirectly to a machinery frame 86. For the transport of workpieces 9 to and from the individual forming stations there is provided a workpiece transport device having four gripping tongs 1. The gripping tongs 1 are on the one hand transversely displaceable, for which purpose they are mounted on a transverse transport block 4 which is transversely displaceable by means of a transverse transport tube. On the other hand, the gripping tongs 1 can be opened and closed and at the same time raised or lowered, which is effected by means of a mechanism explained in detail below. For opening or closing the gripping tongs 1 there is provided a drive rod 3 displaceable in the longitudinal direction thereof, which drive rod is longitudinally displaceable by means of an adjusting device 5, as described in greater detail hereinbelow in connection with FIG. 12.

The following statement applies to all of the further description: where reference numerals are present in a Figure for the purpose of clarifying the drawing but are not explained in the directly associated descriptive text, or vice versa, reference should be made to where they are mentioned in the preceding descriptions of the Figures.

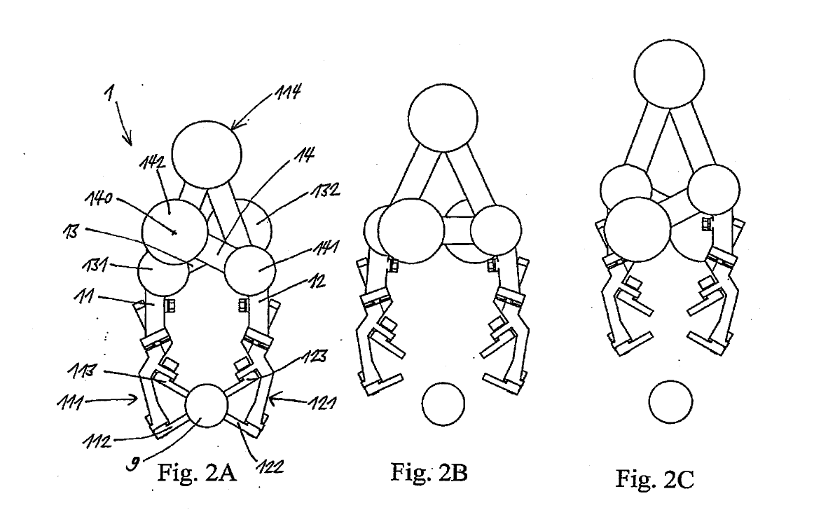

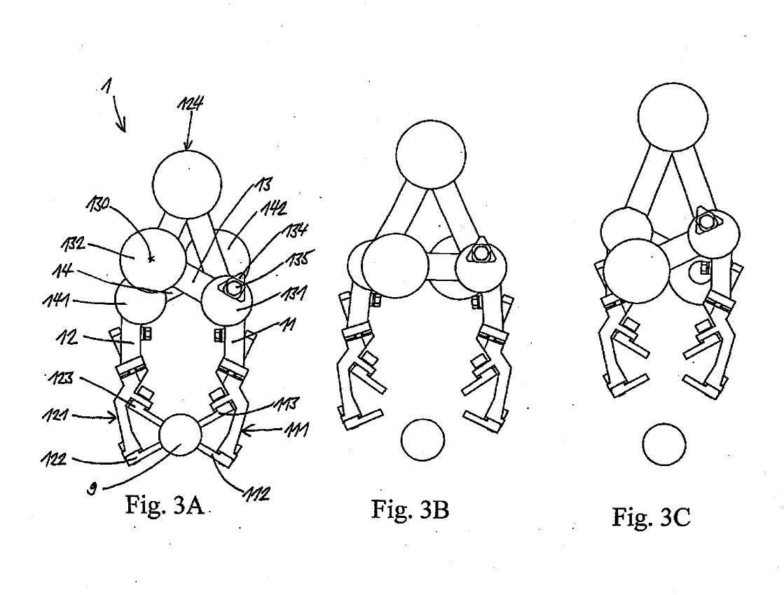

FIGS. 2A, 2B, 2C, 3A, 3B, 3C, 4A, 4B and 4C show important elements of a gripping tongs 1 in a lower end position, a middle position and an upper end position. In the lower end position shown in FIGS. 2A, 3A and 4A, the gripping tongs 1 is closed and grips a workpiece 9. In the middle position shown in FIGS. 2B, 3B and 4B, the gripping tongs 1 has been opened to the maximum extent and raised to half the maximum height. In the upper end position shown in FIGS. 2C, 3C and 4C, the gripping tongs 1 has been closed again and raised to maximum height.

The gripping tongs 1 comprises two non-crossing gripper arms 11 and 12 which are pivotable with respect to one another, the arms each having a gripping end 111, 121, respectively, for gripping the workpiece 9. Screwed onto each of the gripping ends 111, 121 are two gripping elements 112, 113 and 122, 123 which between them hold the workpiece 9.

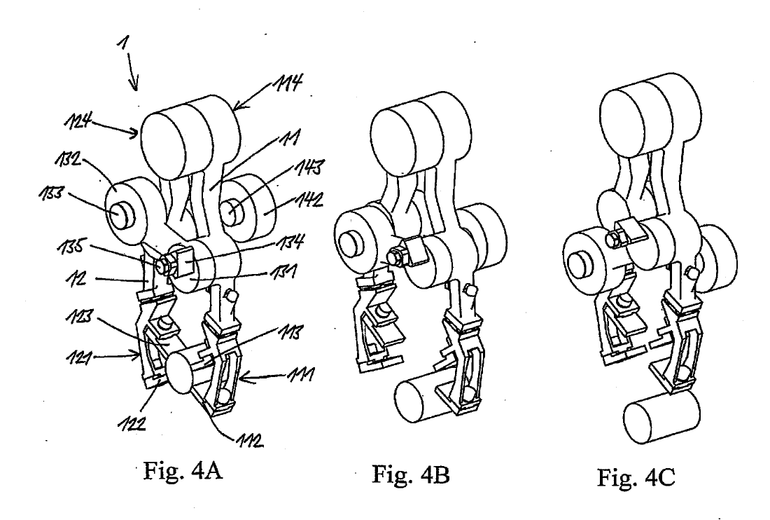

On the end of 114, 124 opposite from the gripping end 111, 121, each of the two gripper arms 11, 12 is articulated on a common pivot shaft which is not shown herein. In a middle region between the two ends, the gripper arms 11, 12 are each articulated by means of a pivot shaft (not visible) on an end 131, 141 of its own link bar 13, 14, respectively. The two link bars 13, 14 are each rotatable about a fixed pivot 130, 140, which is located in the middle of the other end 132, 142 of the link bar 13, 14, respectively. As can be seen from FIGS. 4A, 4B and 4C, in this exemplary embodiment such an arrangement is realised by fixed pivot shafts 133, 143 in the middle of the link bar ends 132, 142. The pivots 130, 140 and the fixed pivot shafts 133, 143 are stationary during opening and closing of the gripping tongs 1; they move too only during transverse transport of the gripping tongs 1.

According to a specific embodiment of the invention, the fixed pivot 130 of the link bar 13 of the gripper arm 11 is arranged closer to the gripper arm 12 than is the fixed pivot 140 of the link bar 14 of that gripper arm 12. In the exemplary embodiment shown, the fixed pivot 130 of the link bar 13 is located virtually directly behind the gripper arm 12. In a corresponding way, the fixed pivot 140 of the link bar 14 of the gripper arm 12 is arranged closer to the gripper arm 11 than is the fixed pivot 130 of the link bar 13 of that gripper arm 11. In the exemplary embodiment shown, the fixed pivot 140 of the link bar 14 is located virtually directly in front of the gripper arm 11.

On the link bar end 131 of the link bar 13 there is mounted a prism element 134 which has a contact face for a drive member (not shown herein). The prism element 134 is screwed onto the link bar end 131 by means of a screw 135.

By pressing of the drive member against the prism element 134 from below, the link bar 13 is rotated, with the result that the gripper arm 11, starting from the lower end position in accordance with FIGS. 2A, 3A and 4A, is first pivoted away from the gripper arm 12 and upwards until the middle position in accordance with FIGS. 2B, 3B and 4B is reached, the upper gripper arm end 114 of the gripper arm 11 pulling the gripper arm 12 upwards, which, as a result of the articulation of the gripper arm 12 on the link bar 14 with the fixed pivot 140, has the result that the gripper arm 12 too is pivoted outwards away from the gripper arm 11. By further upward pivoting of the link bar 13 after the middle position has been reached, the two gripper arms 11, 12 are pivoted further upwards, but towards one another again, until finally the upper end position in accordance with FIGS. 2C, 3C and 4C is reached.

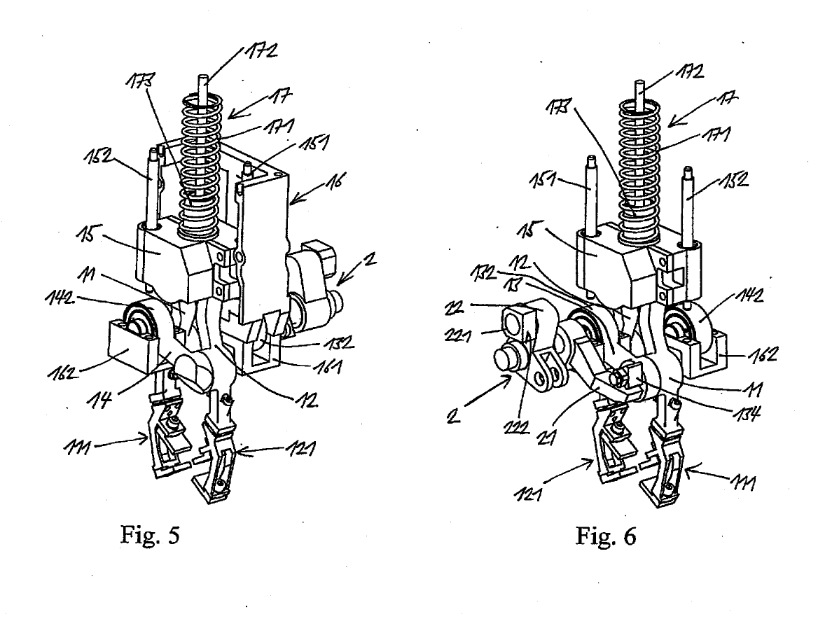

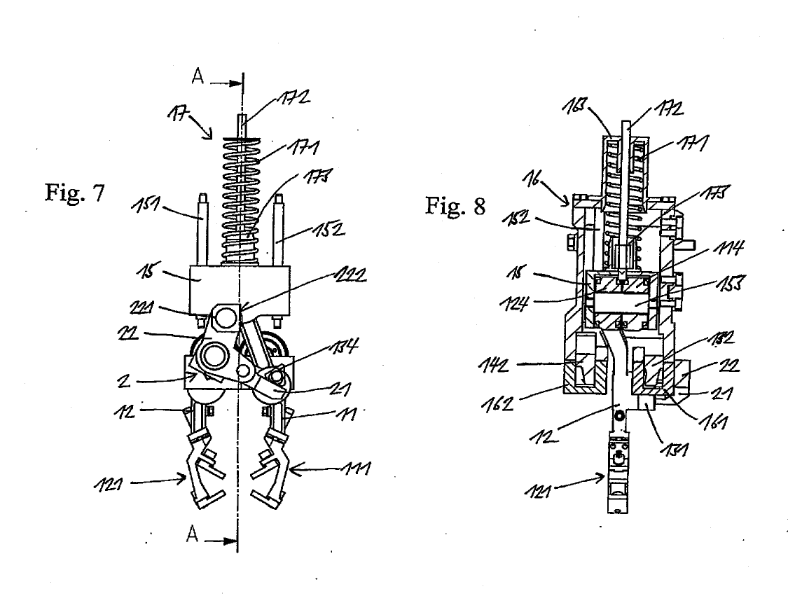

It can be seen from FIGS. 5, 6 and 7 that the link bar ends 132, 142 of the link bars 13, 14 are rotatably mounted in fixed housing parts 161, 162 of a fixed housing 16. The upper gripper arm ends 114, 124 of the gripper arms 11, 12 are articulated on the afore-mentioned common pivot shaft in a common guide head 15 which is mounted so as to be linearly displaceable in the vertical direction on two vertical guide rods 151, 152. On the upper side of the guide head 15 there are mounted a rod 172 and a bearing pin 173 of a biasing device 17, around which a coil spring 171 is arranged. The coil spring 171, the upper end of which rests against a fixed housing part (not shown herein), is biased by compression and exerts on the guide head 15 a force in the direction towards the gripping ends 111, 121 of the gripper arms 11, 12. The guide head 15 acted upon by the coil spring 171 accordingly has the tendency to move the gripper arms 11, 12 into the lower end position or to hold them in that position. Accordingly, the closing of the gripping tongs 1 is effected by the biasing device 17, while the opening is brought about by an active rotary drive means.

Of the rotary drive means there is shown here a drive lever 2 in the form of a two-armed lever, one lever arm 21 of which makes contact as drive member with the prism element 134 of the link bar 13. An attachment 221 having a contact face 222 for a force transmission member is screw-fixed rotatably to the second lever arm 22 of the drive lever 2.

FIG. 8 shows, apart from the components already described, how the upper gripper arm ends 114, 124 of the gripper arms 11, 12 are articulated on a common pivot shaft 153 in the guide head 15. In addition, also shown herein is the fixed housing part 163 of the fixed housing 16, against which the upper end of the coil spring 171 rests.

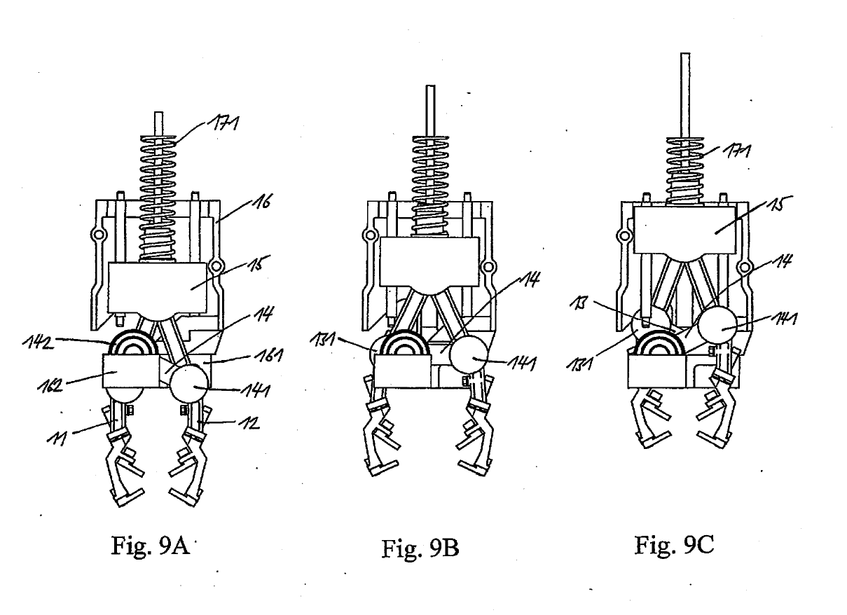

FIGS. 9A, 9B and 9C show above-described parts of the gripping tongs 1 in a view from the front, again in the lower end position, the middle position and the upper end position. It can clearly be seen here how the guide head 15 is displaced linearly upwards in the fixed housing 16 and thus compresses the coil spring 171.

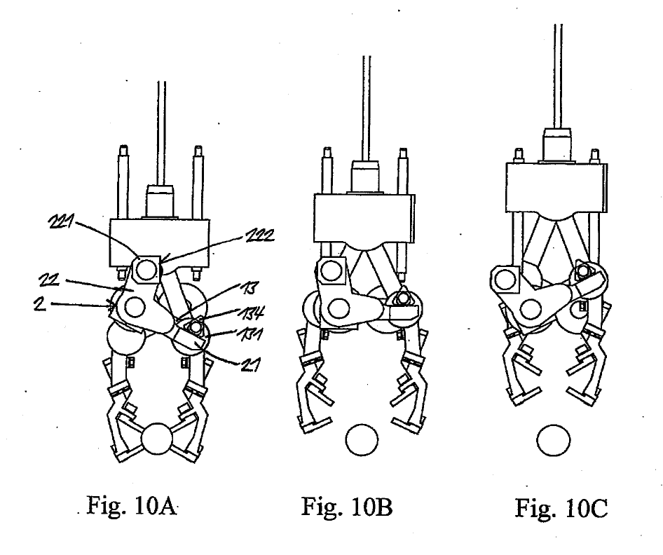

FIGS. 10A, 10B and 10C show especially the rotation of the link bar 13 by means of the drive lever 2 with reference to the lower end position, the middle position and the upper end position of the gripping tongs 1. It can clearly be seen that the lever arm 21 making contact with the prism element 134 of the link bar end 131 rotates the link bar 13 with the prism element 134, while the attachment 221 rotatably mounted on the lever arm 22 retains its alignment relative to the forming machine on simultaneous rotation of the lever arm 22 beneath it. The attachment 221 with the contact face 222 is displaced along an arcuate path from right to left. That allows rotation of the drive lever 2 by linear movement of a force transmission member making contact with the contact face 222.

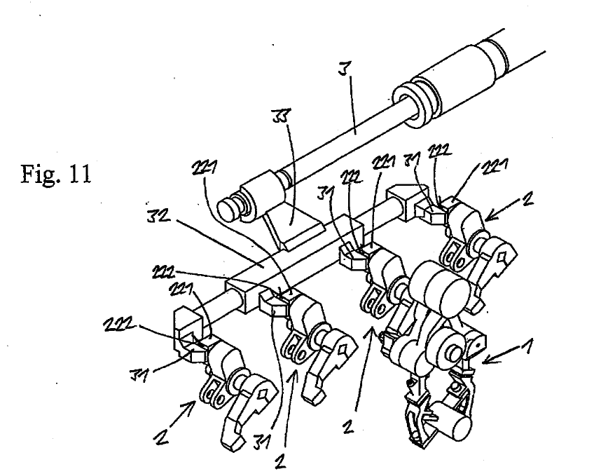

FIG. 11 shows four drive levers 2 arranged one next to the other, parts of the associated gripping tongs 1 also being shown in the case of one drive lever 2. A force transmission member 31 makes contact with each of the contact faces 222 of the attachments 221 of the drive levers 2. All four force transmission members 31 are attached to a common force transmission rod 32 which is connected to the drive rod 3 by means of a connecting part 33. By displacement of the drive rod 3 in its longitudinal direction, all four drive levers 2 can be rotated together.

The drive rod 3 is longitudinally displaceable by means of an adjusting device 5, as shown in FIGS. 12 and 1. The adjusting device 5 comprises in the present case a drive shaft 51 which drives a transmission shaft 52 by means of toothed wheels 511 and 521. The transmission shaft 52 is provided with a cam 522 which presses on a freely rotating roller 531 of a rotary member 53. The rotary member 53 in turn presses on a roller 543 which is mounted so as to be freely rotatable on a free end of a lever arm 541 of a two-armed lever 54. The two-armed lever 54 with the two lever arms 541 and 542 is thus rotated about a fixed pivot shaft 544, the lever arm 542 pulling outwards the connecting member 55 articulated thereon and accordingly the drive rod 3 articulated thereon.

Further structural variations of the workpiece transport device described above can be realised. It should also expressly be mentioned here that instead of the biasing device 17 having the coil spring 171 it would also be possible to use, for example, a pneumatic biasing device. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A workpiece transport device for a forming machine comprising: at least one gripping tongs which has two non-crossing gripper arms which are pivotable with respect to one another, the arms each having a gripping end for gripping a workpiece, each of the two gripper arms being articulated at its end opposite from the gripping end on a common guide head and, in a middle region between the two ends, on its own link bar and the two link bars each being rotatable about a fixed pivot, wherein the fixed pivot of the link bar of one gripper arm is arranged closer to the other gripper arm than is the fixed pivot of the link bar of that other gripper arm.

2. The workpiece transport device according to claim 1, wherein the guide head is linearly displaceable along a fixed guide means so that, on rotation of a link bar the guide head is displaced linearly by the one gripper arm on which that link bar is articulated, with the result that the other gripper arm is displaced too and, as a result of it being articulated on the other link bar, is rotated in the opposite direction to the first gripper arm.

3. The workpiece transport device according to claim 1, further including a biasing device which exerts on the guide head a force in the direction towards the gripping ends of the gripper arms.

4. The workpiece transport device according to claim 1, wherein the two gripper arms are articulated on a common pivot shaft in the guide head.

5. The workpiece transport device according to claim 1, wherein one end of each of the two link bars is mounted in a fixed housing part of the gripping tongs so as to be rotatable about the fixed pivot belonging to the respective link bar.

6. The workpiece transport device according to claim 1, further including a rotary drive means with which one of the link bars is rotatable.

7. The workpiece transport device according to claim 6, wherein the rotary drive means has a drive rod which is displaceable in the longitudinal direction and is connected to one of the link bars by means of intermediate members, so that the link bar is rotatable by longitudinal displacement of the drive rod.

8. The workpiece transport device according to claim 1, further including a plurality of gripping tongs arranged one next to the other which are operable in parallel by means of a drive means.

9. The workpiece transport device according to claim 1, wherein the gripper arms and the link bars are constructed and arranged such that, on rotation of the link bars from one end position to the other, the gripping ends of the two gripper arms are pivoted first away from one another and then towards one another.
